(19) United States
(12) Patent Application Publication
(10) Pub. No.: US 2024/0265896 A1
(43) Pub. Date: Aug. 8, 2024

(54) Grip-Free Percussion Assembly

(71) Applicant: Leroy Baker, Shreveport, LA (US)

(72) Inventor: Leroy Baker, Shreveport, LA (US)

(21) Appl. No.: 18/164,568

(22) Filed: Feb. 4, 2023

(51) Int. Cl. G10D 13/12

(52) U.S. Cl. CPC G10D 13/12

(57) ABSTRACT

A grip-free percussion apparatus has three alloy rods that vary in size and adds an additional palette of sound when the percussion assembly is merged with other percussion instruments.

### CROSS-REFERENCE TO RELATED DOCUMENTS

The present specification claims priority to provisional patent application [serial number] filed on [filing date], and disclosure of which is incorporated herein at least by reference.

### BACKGROUND OF THE INVENTION

### 1. Field of the Invention

The present invention is in the field of percussion and pertains particularly to apparatus for assisting in playing a percussion instrument.

### 2. Discussion of the State of the Art

In the art of percussion, specifically mallet percussion, mallets are objects used to strike or beat a percussion instrument in order to produce its sound. A mallet comprises a head connected to a thin shaft. Some specialized mallets include beaters and drumsticks. Mallets can range in density from hard rubber to soft yarn. Often, mallets of differing material and hardness are used to create different timbres on the same types of instrument.

Mallet percussion instruments are typically a group of pitched percussion instruments. These instruments can feature bars made of wood or metal arranged like a piano keyboard. You can strike its wooden bars with mallets and play individual pitches or, you can put multiple mallets in each hand to play chords.

One limitation with traditional percussion mallets is that one cannot move as freely when playing percussion, especially between two or more percussion instruments. As mentioned above, one would have to hold anywhere from one to multiple percussion mallets in order to successfully play anywhere from individual pitches or chords. One other alternative to simultaneous grip of percussion mallets is multiple percussion mallets within the player's grasp. Both of these, as well as other options limit the player's ability to move freely.

Therefore, what is clearly needed is a grip-free percussion apparatus (and method?) that solves the problems mentioned above.

### SUMMARY OF THE INVENTION

In one embodiment of the invention a grip-free percussion apparatus is provided, comprising three alloy rods that vary in size, and an additional palette of sound when the percussion assembly is merged with other percussion instruments

### BRIEF DESCRIPTION OF THE DRAWING FIGURES

FIG. 1 is a plan view of a grip-free percussion system according to an embodiment of the present invention.

FIG. 2 is a back view of the grip-free percussion system of FIG. 1.

### DETAILED DESCRIPTION OF THE INVENTION

The present invention is described in enabling detail using following examples, which may describe more than one relevant embodiment falling within the scope of the present invention.

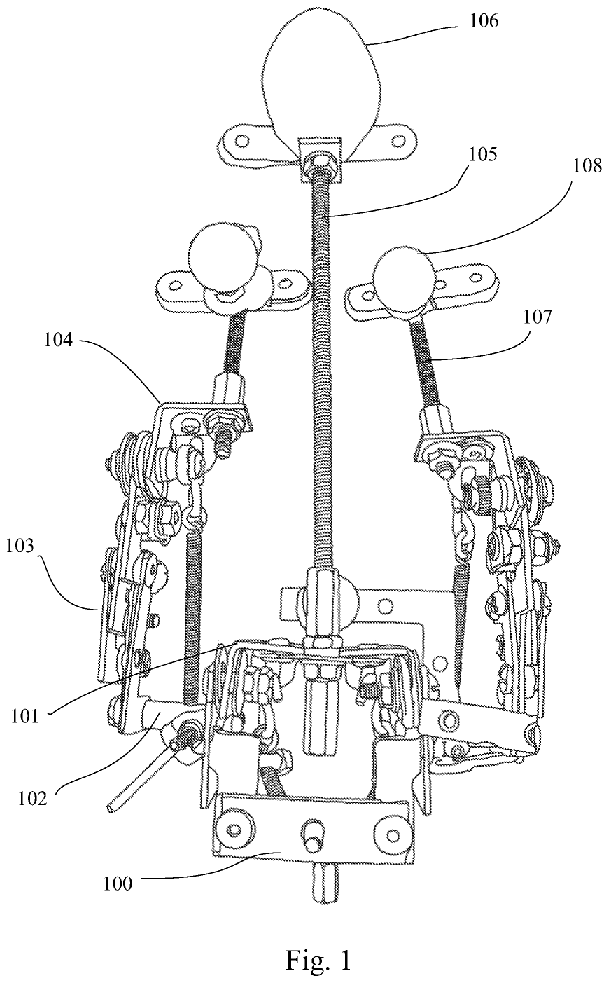

With reference to FIG. 1 showing a top isometric view of the Grip-Free Percussion System comprises a frame mounting bracket 100, featuring L-supports, bent and rivet to frame mounting bracket creating a support assembly. A double L-support motion joint 101, is connected to the left and right support assembly with lock nuts, bolts and washers. Lift and right spacers 102, connect support wing braces 103, which in turn connect the accent arm L-support bracket 104. Connected to the double L-support motion joint 101, main striker rod 105, and main stricker exchangeable tonehead 106.

Accent arm L-support 104 supported by wing braces 103, connects accent striker rod 107, and accent stricker exchangeable tonehead 108.

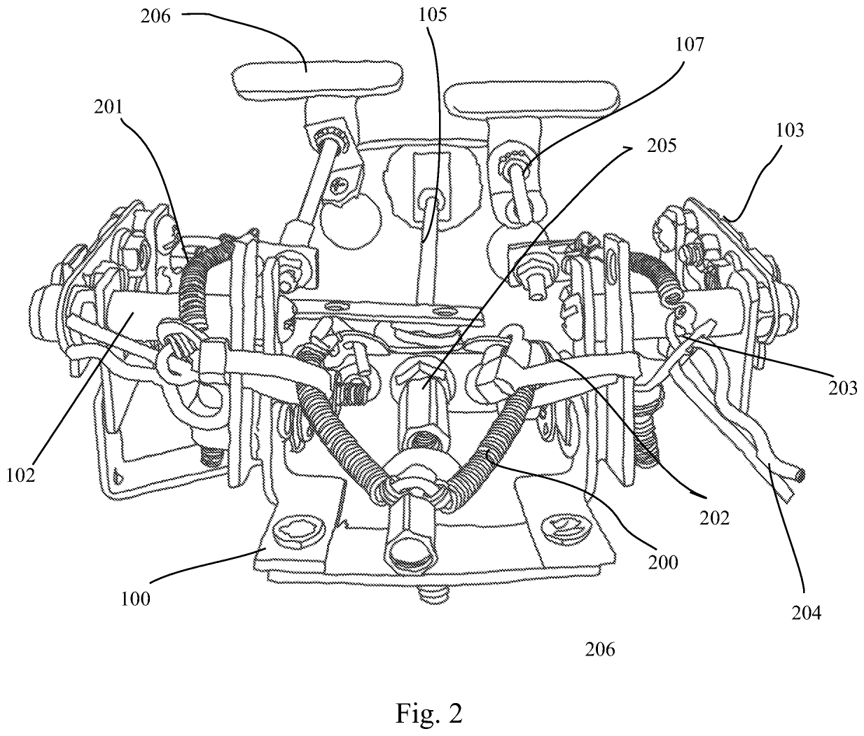

The embodiment of FIG. 2 shows main striker rod 105, tension spring 200 and accent striker rod 107, tension spring 201. Tension spring adjuster 202. Tension spring retainer 203, keep spring catch 204 at desired tension on accent stricker 107. 205 adjustment for main striker rod 105. 206 Sticker pad.

It will be apparent to one with skill in the art that the grip-free percussion a of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

1. A grip-free percussion apparatus, comprising:
a frame mounting bracket;
three alloy rods that vary in size, the three alloy rods comprising:
a main striker rod supported by the frame mounting bracket; and
a pair of accent striker rods supported by the frame mounting bracket on respective sides of the main striker rod;
a main striker tonehead on the main striker rod;
a pair of accent striker toneheads on the pair of accent striker rods, respectively; and
a pair of tension springs extending between the frame mounting bracket and the pair of accent striker rods, respectively.

2. The grip-free percussion apparatus of claim 1 further comprising a pair of spacers supported by the frame mounting bracket, and wherein the pair of accent striker rods is supported by the pair of spacers, respectively.

3. The grip-free percussion apparatus of claim 2 further comprising a pair of support wing braces supported by the pair of spacers, respectively, and wherein the pair of accent striker rods is supported by the pair of support wing braces, respectively.

4. The grip-free percussion apparatus of claim 3 further comprising a pair of accent arm L-support brackets supported by the pair of support wing braces, respectively, and wherein the pair of accent striker rods is supported by the pair of accent arm L-support brackets, respectively.
